(19) United States
(12) Patent Application Publication
(10) Pub. No.: US 2009/0231303 A1
(43) Pub. Date: Sep. 17, 2009

(54) Input system, input device, and input method

(75) Inventor: Guosheng Lin, Hyogo (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-Shi (JP)

(21) Appl. No.: 12/382,045

(22) Filed: Mar. 6, 2009

(30) Foreign Application Priority Data
Mar. 12, 2008 (JP) 2008-063126

(51) Int. Cl. G06F 3/045

(52) U.S. Cl. 345/174

(57) ABSTRACT

An input system includes an input unit with a touch panel, a plurality of seating regions in which an operator can be seated, each of the seating region having an individual electric characteristic and connected to an electric base, an electric-signal supply unit that supplies an electric signal to the input unit with respect to the electric base, and a seating-region specifying unit that detects a response passing between the input unit and the electric base via the operator and the seating region in which the operator is seated, corresponding to the electric signal, when the operator operates the input unit, and that specifies the seating region in which the operator operating the input unit is seated from the detected response, based on the response information having each seating region in which the operator is seated related to the response.

### CROSS-REFERENCE TO RELATED APPLICATION(S)

This application is based upon and claims the benefit of priority of the prior Japanese Patent Application No. 2008-063126, filed on Mar. 12, 2008, the entire contents of which are incorporated herein by reference.

### BACKGROUND OF THE INVENTION

1. Field of the Invention

The present invention relates to an input system that includes a touch panel display, specifies an operator who operates the touch panel display, and performs a process corresponding to the operation performed by the operator, and relates to an input device, and an input method.

2. Description of the Related Art

Conventionally, vehicles and the like have a car navigation system including a television and a navigation device incorporated therein. While conventional car navigation systems were able to provide only one of a television and a navigation device at a time, recently, there have been distributed car navigation systems incorporated with a dual-view liquid-crystal display using a touch panel to provide separate images for a driver seat and at a passenger seat, as well as car navigation systems incorporated with a remote-controlled dual-view liquid-crystal display.

According to the car navigation system incorporated with a dual-view liquid-crystal display using a touch panel, separate images and separate operation input images are provided for the driver seat and to the passenger seat. However, because the touch panel as an input unit (operation unit) is commonly used at the driver seat and at the passenger seat, the navigation system cannot determine whether the operation is performed by a driver or by a passenger sitting in the passenger seat. Therefore, this car navigation system causes the following problem. For example, when a passenger in the passenger seat operates the touch panel in an attempt to increase the sound volume, the car navigation system mistakenly recognizes this operation such that the driver in the driver seat operates to change a display format of the car navigation device which the driver is looking at, instead of recognizing that the operation is to increase the sound volume. As a result, the car navigation system performs an operation which the passenger in the passenger seat and the driver in the driver seat do not intend to.

To solve this problem, various techniques are disclosed to detect an operation by distinguishing between an operation performed by a passenger in a passenger seat and an operation performed by a driver in a driver seat, and achieve an operation corresponding to the detected operation.

Japanese Patent Application Laid-open No. 2006-47534 discloses the following technique. Currents of different frequencies are supplied from separate power sources to a driver seat and to a passenger seat. A touch panel detects a corresponding current and determines a frequency, thereby detecting an operation by distinguishing between an operation at the driver seat and an operation at the passenger seat.

Japanese Patent Application Laid-open No. 2005-104351 discloses an in-vehicle printer system with the following technique. A seating detector is provided at the passenger seat, and when a passenger sitting in the passenger seat operates an input unit, an electric closed loop is formed by the operator, the seating detector, and a wiring, thereby distinguishing between an operation performed by the driver sitting in the driver seat and an operation performed by a person sitting in the passenger seat, other than the driver.

However, the conventional techniques disclosed in Japanese Patent Application Laid-open No. 2006-47534 and Japanese Patent Application Laid-open No. 2005-104351 require embedding of an electrode into seats, and it results in a high manufacturing cost. When seats are already arranged in a used car or the like, a laborious work is necessary either to change the seats or to embed electrodes into the seats when the above techniques are to be applied.

### SUMMARY OF THE INVENTION

It is an object of the present invention to at least partially solve the problems in the conventional technology.

According to an aspect of the invention, an input system includes an input unit having a touch panel; a plurality of seating regions in which an operator can be seated, each of the seating region having an individual electric characteristic and connected to an electric base; an electric-signal supply unit that supplies an electric signal to the input unit with respect to the electric base; and a seating-region specifying unit that detects a response passing between the input unit and the electric base via the operator and the seating region in which the operator is seated, corresponding to the electric signal, when the operator operates the input unit, and that specifies the seating region in which the operator operating the input unit is seated from the detected response, based on response information having each seating region in which the operator is seated related to the response.

According to another aspect of the invention, an input device includes an input unit having a touch panel; an electric-signal supply unit that supplies an electric signal to the input unit with respect to an electric base; and a seating-region specifying unit that detects when an operator seated in one of a plurality of seating regions in which the operator can be seated, each having an individual electric characteristic and connected to the electric base, operates the input unit, a response passing between the input unit and the electric base via the operator and the seating region in which the operator is seated, corresponding to the electric signal, and that specifies the seating region in which the operator operating the input unit is seated from the detected response, based on response information having each seating region in which the operator is seated related to the response.

According to still another aspect of the invention, an input method for specifying one of a plurality of seating regions in which an operator can be seated, each having an individual electric characteristic and connected to an electric base when the operator operates an input unit having a touch panel, the input method includes supplying an electric signal to the input unit with respect to the electric base; detecting a response passing between the input unit and the electric base via the operator and the seating region in which the operator is seated, corresponding to the electric signal, when the operator operates the input unit; and specifying the seating region in which the operator operating the input unit is seated from the detected response, based on response information having each seating region in which the operator is seated related to the response.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram for explaining an outline and characteristics of an in-vehicle system according to a first embodiment of the present invention;

FIG. 2 is a block diagram of a configuration of the in-vehicle system according to the first embodiment;

FIG. 3 is a flowchart for explaining of an operation of the in-vehicle system according to the first embodiment;

FIG. 4 is a schematic diagram for explaining operation timings in the in-vehicle system according to the first embodiment;

FIG. 5 is a schematic diagram for explaining a response detected by an electric-signal supply/response detector;

FIG. 6 is a flowchart for explaining an operation of an in-vehicle system according to a second embodiment of the present invention; and

FIG. 7 is a flowchart for explaining an operation to perform a characteristic-change-time register process.

### DETAILED DESCRIPTION OF THE PREFERRED EMBODIMENTS

Main terms used in exemplary embodiments of the present invention are explained first. “In-vehicle system” (corresponding to “input system”, “input device”, and “input method” in the appended claims) used in the embodiments of the present invention represents a computer system such as a car navigation system incorporated in a car. Specifically, the in-vehicle system displays car navigation and a television on a liquid crystal monitor and the like, and receives various kinds of operation from a touch panel or by remote control. The “in-vehicle system” such as this car navigation system displays car navigation or a television on the liquid crystal monitor. When car navigation is displayed, the in-vehicle system receives setting of a target place or switching of a display format from the touch panel of the liquid crystal monitor, and performs the setting or switching. When the television is displayed, the in-vehicle system performs switching of a channel or adjustment of a sound volume. When the in-vehicle system includes a dual-view liquid-crystal display that displays different images at the driver seat and at the passenger seat, generally, the in-vehicle system displays two images on screens, and shares the touch panel or switches that are used to perform various operations.

A recent car navigation system (“in-vehicle system”) decreases load applied to a driver by inserting a digital versatile disk (DVD) into the system and by connecting a digital camera to the system, using a television and a car navigation device as well. The car navigation system also provides comfortable driving and provides various services to make passengers comfortable. Therefore, the car navigation system including a dual-view liquid-crystal display that displays different images at the driver seat and at the front and back passenger seats provides separate services to make both the driver and passengers comfortable, thereby further increasing comfortableness to the driver and the passengers. Although the car navigation system has been mainly operated by remote control in the past, the operation using the touch panel has decreased load of the users. In the following embodiments, explanations are made based on an assumption that the operation performed by the driver in the driver seat is distinguished from the operation performed by the passenger in the passenger seat. However, the present invention is not limited thereto, and an operation by the driver in the driver seat, an operation by the passenger in the passenger seat, and an operation by a passenger in the back passenger seat can be distinguished from each other. In the embodiments, it is assumed that a car navigation system according to the present invention is incorporated in a vehicle body as an in-vehicle system. However, the present invention is not limited thereto, and the invention can be applied to all cases where a dual-view liquid-crystal display or a multi-view liquid-crystal display of a television is used.

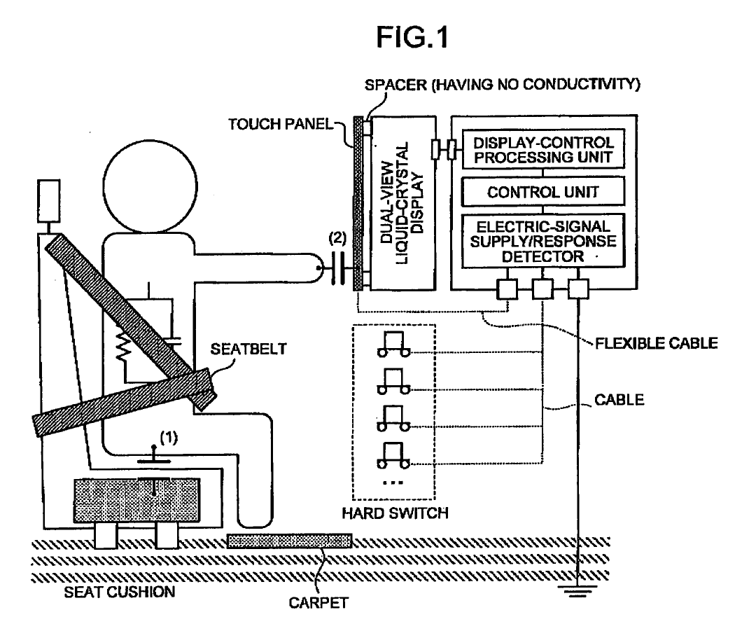

An outline and characteristics of an in-vehicle system according to a first embodiment of the present invention are explained below with reference to FIG. 1. FIG. 1 is a schematic diagram for explaining the outline and the characteristics of the in-vehicle system according to the first embodiment.

FIG. 1 depicts the in-vehicle system according to the first embodiment, and an operator who operates the in-vehicle system. Although FIG. 1 depicts only one seat, there are two seats including a passenger seat and a driver seat in practice. The seat is a holding device that holds an operator without causing the operator to directly touch a vehicle body, when the operator is seated in a normal way of sitting. That is, the seat includes a chair, a seat cover, a cushion, and a carpet. The seat also includes a seatbelt which the driver and the passenger have a legal obligation to wear in the driver seat and in the passenger seat, respectively, when the driver drives a vehicle. The seat corresponds to “seating region” in the claims. The seatbelt corresponds to “securing device” in the claims.

The in-vehicle system includes these seats, a touch panel, a hard switch, a dual-view liquid-crystal display holding the touch panel with a nonconductive spacer, and capable of displaying different images at a driver seat side and at a passenger seat side, a display-control processing unit that processes a display output from the dual-view liquid-crystal display, an electric-signal supply/response detector that applies an electric signal to the touch panel and the hard switch through a flexible cable or a cable using the hard switch and the vehicle body as an earth, and detects a response corresponding to the electric signal, and a control unit that analyzes this response. The driver seat and the passenger seat arranged in the vehicle body have mutually different electric characteristics.

Because the driver seat and the passenger seat have mutually different electric characteristics in the in-vehicle system, when either the driver or the passenger in the driver seat or in the passenger seat operates the touch panel or the hard switch, a response passing through the seat and the body of the operator corresponding to an electric signal supplied to the touch panel and the hard switch is different at each seat. The control unit holds information in advance which relates the response to each seat so that a seat in which the operator is seated can be specified from this response. When the response is detected, the control unit specifies a seat in which the operator is seated, based on this information. Therefore, the control unit can determine whether the driver sitting in the driver seat operates the touch panel or the hard switch or a passenger sitting in the passenger seat operates the touch panel or the hard switch, without requiring an electrode to be embedded into each seat.

This is explained in further detail with an example. When an operator operates the touch panel with a finger while sitting in the seat, an electric relationship between the operator and the seat and an electric relationship between the finger of the operator and the touch panel are in a relationship between electrodes of a pseudo capacitor (numbers (1) and (2) in FIG. 1) as depicted in FIG. 1. Impedances of human bodies are thought to be different between individuals within a range of 21 and 617 kiloohms in a certain condition. Assume as an electric characteristic of a seat, for example, that a difference between impedances of the seats is larger than a difference between the impedances of individuals, such as the impedance of the passenger seat is 1 megaohm and the impedance of the driver seat is 2 megaohms. The impedances of the seats change in a large order of megaohms or more. Compare a case that an operator seated in the passenger seat operates the touch panel and a case that an operator seated in the driver seat operates the touch panel. Electric charges gathered at the seat side of the pseudo capacitor indicated by the number (2) in FIG. 1 are different between these two cases. When a signal to charge a predetermined amount of electric charge is set as an electric signal to be supplied to the touch panel and the hard switch, a current flowing between the touch panel and the vehicle body via the operator and the seat and a voltage which changes following this current are greatly different between the seats in excess of the individual difference between the impedances of the human bodies, due to different ways of gatherings of electric charges.

The control unit holds response information which relates a response to a seat in which an operator is seated so that the control unit can specify whether a seat in which the operator is seated is the driver seat or the passenger seat from a response to an electric signal having a different tendency for each seat, and specifies based on this response information the seat in which the operator who operates the touch panel is seated. The response information can be any information having a content which enables a seat to be specified from the response, such as a representative response-example classified for each seat and range information which enables a seat to be specified from the impedance. For example, when a total impedance of an operator and a seat derived from the response is 1 megaohm, the control unit can determine that the operator is seated in the passenger seat. When a total impedance of an operator and a seat derived from the response is 2 megaohms, the control unit can determine that the operator is seated in the driver seat.

The above electric characteristics and electric signals are only one example, and any other kinds of electric characteristics and electric signals that can specify each seat from the response can be specified, regardless of an individual difference between electric characteristics of human bodies of operators. As another example, the following alternating current can be used as an electric signal. An impedance of the driver seat and an impedance of the passenger seat are set mutually different, and these impedances have frequency responses different from frequency responses of a human body. An alternating current properly set with a frequency so that a voltage change having a different tendency at each seat due to the difference between the frequency responses is detected as a response is used for the electric signal.

In setting the electric characteristic of each seat, a whole one set of a seat does not need to be changed. For example, an electric characteristic of each seat can be set differently from each other by changing only a cushion or a seat cover. When an electrode is embedded beforehand into one of the driver seat and the passenger seat, a difference between electric characteristics attributable to presence or absence of the electrode can be utilized. When electrodes are embedded beforehand into both the driver seat and the passenger seat, cushions having mutually different electric characteristics for these seats can be set on these electrodes.

As explained above, the in-vehicle system according to the first embodiment determines a seat in which an operator is seated based on a difference between electric characteristics of the seats. Therefore, the in-vehicle system can specify a seat in which the operator is seated, without providing an electrode in the seat, as explained above.

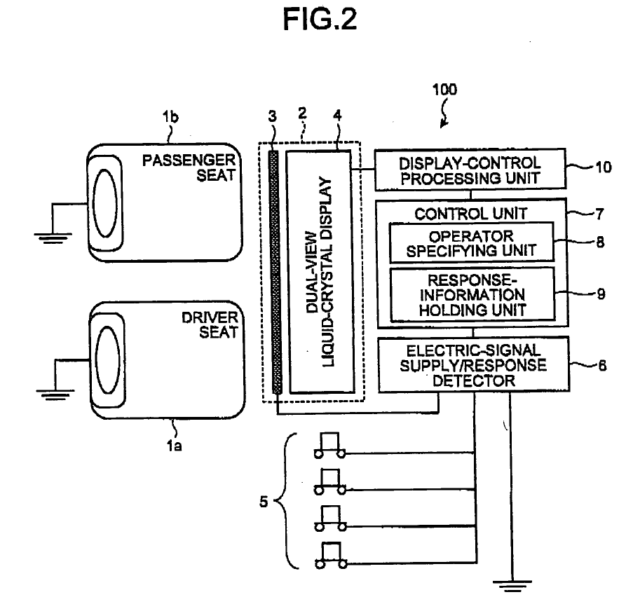

A configuration of the in-vehicle system depicted in FIG. 1 is explained next with reference to FIG. 2. FIG. 2 is a block diagram of the configuration of the in-vehicle system according to the first embodiment. As depicted in FIG. 2, an in-vehicle system 100 includes a seat 1a as a driver seat, a seat 1b as a passenger seat, a touch panel display 2 having a touch panel 3 and a dual-view liquid-crystal display 4, a hard switch 5, an electric-signal supply/response detector 6, a control unit 7 having an operator specifying unit 8 and a response-information holding unit 9, and a display-control processing unit 10.

The seat 1a and the seat 1b are holding devices that hold an operator when the operator is seated, including the seat main body arranged in the vehicle body, the seat cover, the cushion, and the carpet, as described above. Each seat includes a seatbelt. The seats 1a and 1b have mutually different electric characteristics so that the in-vehicle system can distinguish a response which passes through one of the seats, even if there is an individual difference between impedances of human bodies, from the response passing through the operator and the seats 1a and 1b corresponding to an electric signal flowing from the electric-signal supply/response detector 6 when the operator operates the touch panel 3 by being seated. For example, as described above, the seats 1a and 1b can have an impedance difference larger than the individual difference between impedances of human bodies.

Alternatively, the impedances of the seats 1a and 1b can have mutually different frequency responses. When a used car or a new car at its manufacturing time does not take incorporating the in-vehicle system into consideration, and also when electric characteristics of seat main bodies arranged in advance are equal at the seat 1a and the seat 1b, each seat can have an individual electric characteristic by changing materials of the seat cover, the cushion, the seatbelt, and the carpet.

The touch panel display 2 includes the touch panel 3 and the dual-view liquid-crystal display 4 superimposed with each other. The touch panel display 2 displays various images and moving images. The touch panel 3 is an input unit that receives various operations input by the operator.

The touch panel 3 includes matrix switches, resistance film switches or the like, and transmits an output signal generated by pressing a position corresponding to a display on the dual-view liquid-crystal display 4, to the electric-signal supply/response detector 6. The touch panel 3 also has a function of an electrode that receives an electric signal from the electric-signal supply/response detector 6 when an operation is performed, and detects a response. That is, when the operator performs the operation by touching the touch panel 3, a closed loop is formed by the touch panel 3, the operator, the seat 1a or the seat 1b, the vehicle body to which each seat and the electric-signal supply/response detector 6 are earthed, and the electric-signal supply/response detector 6. When the electric-signal supply/response detector 6 supplies an electric signal, a current flows to the touch panel 3 or a voltage changes according to electric characteristics of the operator and the seat.

The dual-view liquid-crystal display 4 can output two different images, as an image observed from the driver seat and an image observed from the passenger seat. For example, the images are set so that the image observed at the passenger seat is a television screen and the image observed at the driver seat is a car navigation screen The display-control processing unit 10 generates the image to be displayed in the dual-view liquid-crystal display 4, based on an instruction from the control unit 7.

The hard switch 5 is a hardware switch to operate the in-vehicle system, and is arranged at a side of the touch panel display 2 of the in-vehicle system as a representative example. The operation of the in-vehicle system includes sound volume adjustment, switching of a navigation screen, and various kinds of setting. The hard switch 5 functions as an electrode that transmits an output signal generated when the hard switch 5 is pressed by an operator, to the electric-signal supply/response detector 6, receives an electric signal by the electric-signal supply/response detector 6, and detects a response, like the touch panel 3.

The touch panel 3, or the touch panel 3 and the hard switch 5 correspond to “input unit” in the claims.

The electric-signal supply/response detector 6 transmits an input signal representing a content of an operation to the operator specifying unit 8, when the operator is operating the in-vehicle system by pressing a soft button of the touch panel 3 or by pressing the hard switch 5. The electric-signal supply/response detector 6 applies electric signals of plural patterns set in advance, to the touch panel 3 and the hard switch 5, based on an instruction from the operator specifying unit 8. In this case, the electric-signal supply/response detector 6 detects as a response at least one of a current flowing through the touch panel 3 or through the hard switch 5 and a voltage corresponding to the electric signals, in a closed loop formed by the touch panel 3 or the hard switch 5, the operator, the seat 1a or 1b, the vehicle body, and the electric-signal supply/response detector 6. The electric-signal supply/response detector 6 transmits the detected response to the operator specifying unit 8. The electric signals are set to detect a difference between the electric signal of the seat 1a and the electric signal of the seat 1b, as described above. The patterns of the electric signals are a current or a voltage of a sine wave, a pulse wave, or a direct current, and a predetermined amount of electric charge, for example. A frequency can be changed as a pattern. Any kind of a detection method of an electric signal pattern and a response can be set when the response has a different tendency based on a difference between the electric characteristics of the seats 1a and 1b, by arranging such that when the electric signal is given as a current, a voltage is measured as the response, when the electric signal is given as a voltage, a current is measured as the response, and when the electric signal is given as a predetermined amount of electric charge, a voltage and a current are measured as the response, for example. The function of the electric-signal supply/response detector 6 that supplies an electric signal corresponds to “electric-signal supply unit” in the claims.

The control unit 7 includes an internal memory to store a control program of an operating system (OS) and the like, a program prescribing various process procedures of the in-vehicle system, and required data. Particularly, the control unit 7 includes the operator specifying unit 8, and the response-information holding unit 9 that are closely related to the present invention, and performs various processes by these units.

When the operator specifying unit 8 detects via the electric-signal supply/response detector 6 the operation of the touch panel 3 or the hard switch 5 performed by the operator by receiving an input signal transmitted from the electric-signal supply/response detector 6, the operator specifying unit 8 causes the electric-signal supply/response detector 6 to generate electric signals of plural patterns set in advance. The operator specifying unit 8 receives each response corresponding to each electric signal of each pattern from the electric-signal supply/response detector 6.

The response-information holding unit 9 holds response information as information which relates the above response to a seat in which the operator operating the touch panel 3 and the hard switch 5 is seated. That is, when the response-information holding unit 9 references the response information by specifying a pattern of an electric signal and a response to this electric signal the response-information holding unit 9 can determine whether the operator has operated the touch panel 3 and the hard switch 5 at the seat 1a or at the seat 1b. While the operator wears a seatbelt when the vehicle is running, the operator does not necessarily wear it when the vehicle is parked. Therefore, the response information includes two kinds of information to be able to respond to both cases where the operator operates the touch panel 3 and the hard switch 5 without wearing the seatbelt and where the operator operates the touch panel 3 and the hard switch 5 while wearing the seatbelt. A sensor of the seatbelt can select response information.

When the operator specifying unit 8 receives each response corresponding to an electric signal of each pattern, the operator specifying unit 8 references the response information held by the response-information holding unit 9 by specifying a pattern of the electric signal and a response, and determines a seat in which the operator is seated corresponding to each response. When the determination of responses corresponding to all supplied patterns of electric signals ends, the operator specifying unit 8 specifies whether the operator has operated at the seat 1a or at the seat 1b based on a result of the determination, for example, by a majority decision.

The control unit 7 causes the in-vehicle system to perform an output corresponding to the operator and the input signal, based on the result specified by the operator specifying unit 8 and the input signal. The display-control processing unit 10 generates the image to be displayed in the dual-view liquid-crystal display 4, based on an instruction from the control unit 7.

An exemplified operation is described below. Assume that increasing a sound volume of a television and switching a display of car navigation are performed at the same operation position on the touch panel. In this case, when an input signal at the operation position and a response that can be specified as the operation at the driver seat are detected, the control unit 7 instructs the display-control processing unit 10 to switch the display of the car navigation or causes a corresponding device to perform the switching. When a response that can be specified as the operation at the passenger seat is detected, the control unit 7 instructs the display-control processing unit 10 to increase the sound volume of the television or causes a corresponding device to increase the sound volume of the television.

The operation of increasing the sound volume of the television and the operation of switching the display of the car navigation are only one example, and various other operations such as air conditioning can be performed. A collective function of the function of the electric-signal supply/response detector 6 detecting a response, the function of the operator specifying unit 8, and the function of the response-information holding unit 9 corresponds to “seating-region specifying unit” in the claims.

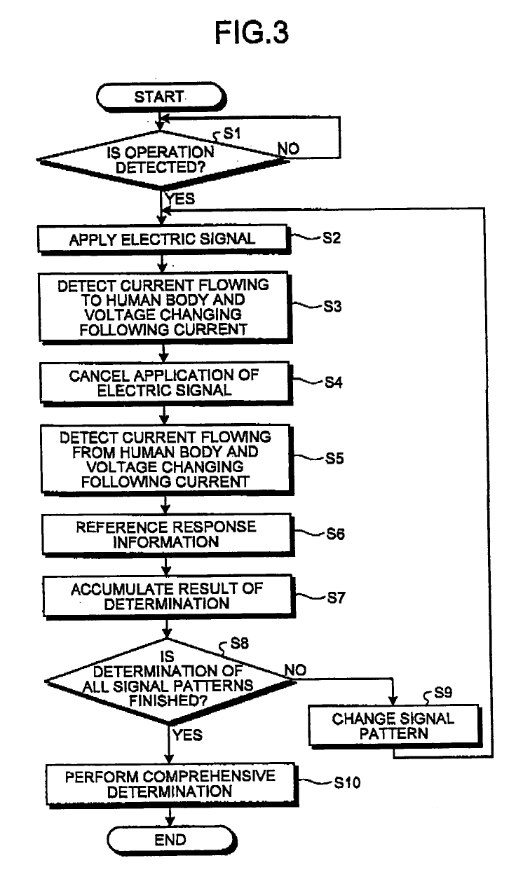

A process performed by the in-vehicle system is explained next with reference to FIG. 3. FIG. 3 is a flowchart of an operator specifying process in the in-vehicle system. There is no difference in the operation of the in-vehicle system between when the operator operates the touch panel 3 and when the operator operates the hard switch 5. Therefore, in the first embodiment, explanations are made based on an assumption that the operator operates the touch panel 3.

In FIG. 3, when the operator operates the touch panel 3, the operator specifying unit 8 receives an input signal via the electric-signal supply/response detector 6, and detects the operation (YES at Step S1). The operator specifying unit 8 instructs the electric-signal supply/response detector 6 to cause the touch panel 3 to supply one of electric signals of plural patterns set in advance (Step S2). As the electric signal of the pattern, it is assumed that a specific amount of electric charge per unit time is supplied during a predetermined period of time.

Thereafter, the electric-signal supply/response detector 6 detects as a response a current flowing from the touch panel to the human body and a voltage which changes accordingly, and transmits the response to the operator specifying unit 8 (Step S3). After a lapse of a predetermined time since the supply of the electric signal is started, the electric-signal supply/response detector 6 cancels the supply of the electric signal by removing the electric signal for applying a specific amount of electric charge per unit time (Step S4). The electric-signal supply/response detector 6 detects as a response a current flowing from the human body and a voltage which changes accordingly, during a predetermined period after the cancel, and transmits the detected response to the operator specifying unit 8 (Step S5).

The operator specifying unit 8 assigns the pattern of the electric signal and the responses detected at Step S3 and Step S5, references response information held in the response-information holding unit 9, and determines whether the operation has been performed at the passenger seat or at the driver seat (Step S6). The operator specifying unit 8 temporarily stores a result of the determination into an internal memory of the control unit 7 (Step S7).

The operator specifying unit 8 determines whether a determination of all kinds of patterns of the electric signals set in advance has been finished (Step S8). When the determination has not been finished yet (NO at Step S8) the operator specifying unit 8 changes a pattern of the electric signal to a next pattern among the patterns set in advance (Step S9), and shifts to Step S2. When the operator specifying unit 8 determines that a determination of all kinds of patterns of the electric signals has been finished (YES at Step S8), the operator specifying unit 8 finally determines whether the operation has been performed at the passenger seat or at the driver seat, based on the stored result of determination (Step S10).

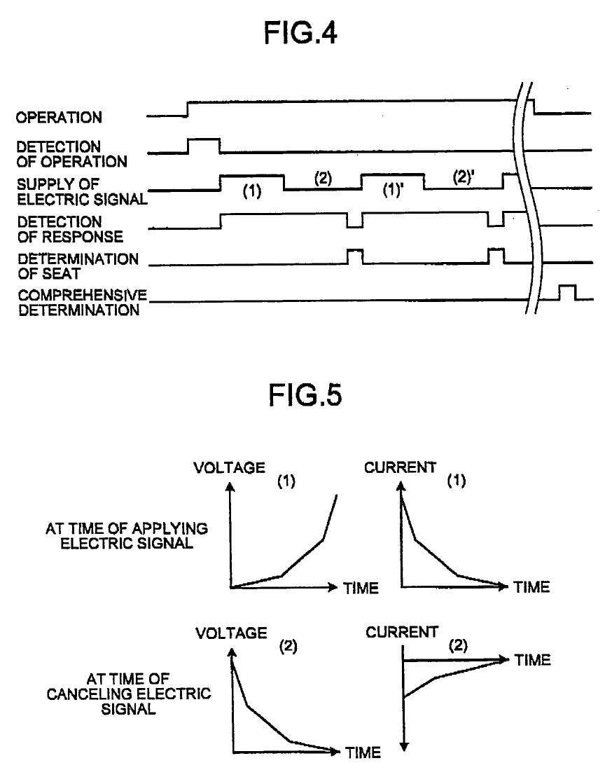

In the above operation of the process flow, timings of the operation by the operator, a detection of the operation, a detection of the response by the electric-signal supply/response detector 6, and a comparison and a determination of a response, and a final determination by the operator specifying unit 8 are explained in detail below with reference to FIG. 4 and FIG. 5. FIG. 4 is a schematic diagram for explaining these timings with a lateral axis as a time axis, and FIG. 5 is a schematic diagram for explaining a detailed response when a specific amount of electric charge per unit time is supplied during a predetermined time.

In FIG. 4, when the operator operates the touch panel 3 as depicted by a top chart, the electric-signal supply/response detector 6 receives an input signal and detects the operation as depicted by a second chart from the top. Corresponding to this detection, the operator specifying unit 8 supplies an electric signal to the electric-signal supply/response detector 6 as depicted by a third chart from the top. The operator specifying unit 8 applies a specific amount of electric charge per unit time, during times indicated by reference numerals (1) and (1)′ in FIG. 4, and cancels the application of the electric charge during times (2) and (2)′ in FIG. 4. Reference numerals (1)′ and (2)′ indicate that electric signals applied during these periods have different patterns from those of the electric signals applied during (1) and (2), respectively, in that signal application periods are different and amounts of electric charges applied per unit time are different. As depicted by a fourth chart from the top, the electric-signal supply/response detector 6 detects a response, when the electric signal is applied and when the application of the electric signal is cancelled.

The response that the electric-signal supply/response detector 6 detects has the following tendencies. As depicted by graphs of a relationship between a voltage and time and a relationship between a current and time indicated by reference numeral (1) in FIG. 5, when an electric signal is applied, a voltage value increases along time, and a current value expresses a high value momentarily at an application time of an electric charge, and decreases along time. When the supply of the electric signal is cancelled, these relationships express opposite tendencies to those at the application time of the electric signal, as depicted by two graphs indicated by reference numeral (2) in FIG. 5.

Referring back to FIG. 4, when the electric-signal supply/response detector 6 detects a response, as depicted by the fourth chart from the top, the operator specifying unit 8 assigns a pattern of the electric signal and a response depicted in FIG. 5, references the response-information holding unit 9, and determines whether the operator has operated at the driver seat or at the passenger seat. The operations in the second to fourth charts from the top are repeated by a number of set patterns of the electric signals. Last, the operator specifying unit 8 specifies whether the seat in which the operator is seated is the driver seat or the passenger seat, at a timing depicted in the fifth chart from the top, based on a result of determination accumulated for each response using each pattern of the electric signal. In a sixth timing chart from the top, the operator specifying unit 8 performs a comprehensive final determination by a majority decision or the like based on a result of the specification made at the timing of the fifth chart from the top.

As described above, according to the first embodiment, seating regions have mutually different electric characteristics. When an operator seated in any one of the seating regions operates an input unit, the in-vehicle system detects a response passing between the input unit and an electric base point via the operator and the seat corresponding to the electric signal supplied to the input unit. The in-vehicle system analyzes the detected response based on response information which relates each seating region to the response, and specifies a seating region in which the operator is seated. Therefore, it is possible to achieve an input system, an input device, and an input method capable of determining a seating region in which the operator is seated, without embedding an electrode into the seating region. Because the response information is configured to relate the seating region to the response regardless of whether the operator is wearing a securing device, the seating region in which the operator is seated can be specified regardless of whether the operator is wearing the securing device.

In the first embodiment, it is explained as the assumption that the operator is not touching any other portions than the seat, the touch panel, and the hard switch. However, when an operator seated in a seat operates the touch panel and the hard switch in a state of touching a portion of the vehicle body, for example, a detected response can change greatly.

In a second embodiment of the present invention, an operator seated in a seat operates a touch panel or a hard switch in a state of touching a portion other than the seated seat, the touch panel, and the hard switch. A portion other than the touch panel and the hard switch of a vehicle body is a door knob, a window frame, an arm rest, a steering wheel at a driver seat side or the like, which are other than the seat, the touch panel, and the hard switch among devices and items incorporated in the vehicle body. A state that the operator is touching these portions is called a vehicle-body contact state. There is no difference in the operation of an in-vehicle system in the second embodiment between when the operator operates the touch panel 3 and when the operator operates the hard switch 5. Therefore, in the second embodiment, explanations are hereinafter performed based on an assumption that the operator operates the touch panel 3.

A configuration of the in-vehicle system according to the second embodiment is equivalent to the configuration of the in-vehicle system according to the first embodiment. Each constituent element has all functions of each constituent element according to the first embodiment. The operator specifying unit 8 and the response-information holding unit 9 have several additional functions to be able to specify an operator even when the operator operates the touch panel in the vehicle-body contact state. These additional functions of the operator specifying unit 8 and the response-information holding unit 9 according to the second embodiment, as additional functions to the first embodiment, are explained below.

The response-information holding unit 9 further holds change information which relates the operation obtained when the operator operates in the vehicle-body contact state to the response information in the first embodiment, for each of the seat 1a and the seat 1b. That is, a seat in which the operator is seated can be determined, by referencing information having the change information applied to the response information by assigning a pattern of the electric signal and a response obtained when the operator seated in each seat operates in the vehicle-body contact state. By estimating in advance a part of the vehicle body an operator in the driver seat and an operator in the passenger seat are in contact respectively, the change information can be set in advance corresponding to this estimation. For example, when the operator is seated in the driver seat, it is preferable to set the change information by estimating a contact of the operator with the steering wheel, a brake pedal, or an accelerator pedal. In this case, the change information corresponds to “change information” in the claims.

When a response is obtained, the operator specifying unit 8 references the response information held in the response-information holding unit 9 by assigning a pattern of the electric signal and the response, and determines whether the response comes from the seat 1a or the seat 1b. When the determination is not successful, the operator specifying unit 8 performs the determination again by applying the change information to the response information. When a response that cannot be determined is obtained even when a reference is made to the response information applied with the change information having a possibility of being detected when the touch panel 3 is operated while touching a portion other than the parts of the vehicle body estimated in advance, this response is transmitted as new response information to the response-information holding unit 9 together with a result of a comprehensive determination regarding whether the operator has operated at the seat 1a or at the seat 1b, and is registered in the response-information holding unit 9.

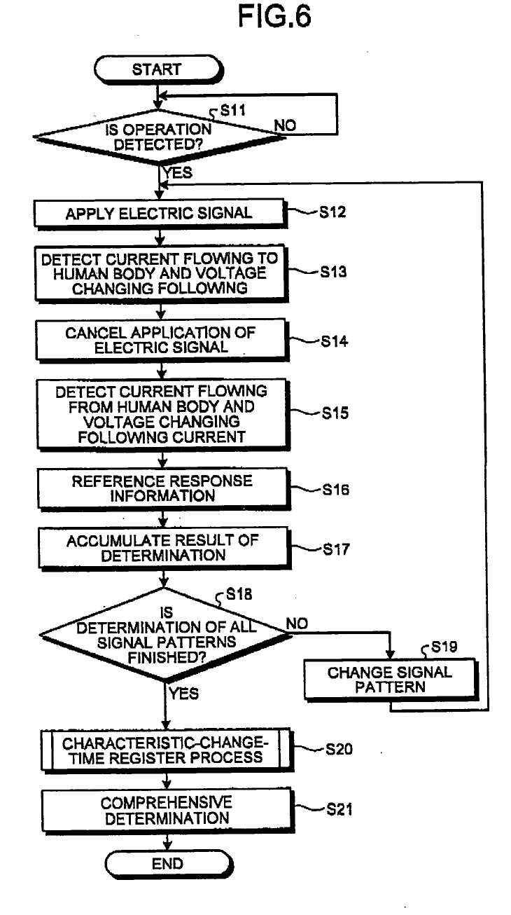

An operation of the in-vehicle system according to the second embodiment is explained next. FIG. 6 is a flowchart for explaining the operation of the in-vehicle system according to the second embodiment. An operation flow from Step S1 to Step S19 is equivalent to that from Step S1 to Step S9 in the flow of the in-vehicle system according to the first embodiment depicted in FIG. 3, and therefore explanations thereof will be omitted.

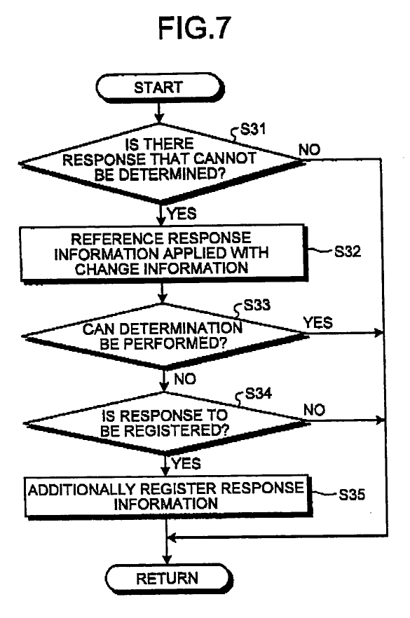

In FIG. 6, when a determination of electric signals of all patterns finishes (YES at Step S18), the operator specifying unit 8 performs a characteristic-change-time register process as a process of performing the determination again and a registration by assuming that the operator is in the vehicle-body contact state, for the response of which determination is unsuccessful (Step S20). FIG. 7 is a flowchart for explaining the operation of the characteristic-change-time register process.

In FIG. 7, when the characteristic-change-time register process is started, the operator specifying unit 8 determines whether there is a response that cannot be determined (Step S31). When there is no response that cannot be determined (NO at Step S31), the operation of the characteristic-change-time register process is returned. When there is a response that cannot be determined (YES at Step S31), the operator specifying unit 8 accesses the response-information holding unit 9, and performs the determination again by using information having the change information applied to the response information, for the response that cannot be determined (Step S32). The operator specifying unit 8 determines whether the determination can be performed again (Step S33). When the determination can be performed again (YES at Step S33), the operator specifying unit 8 stores a result of the determination into the internal memory of the control unit 7, and returns the operation of the characteristic-change-time register process.

When the determination cannot be performed again (NO at Step S33), response information and change information that can determine the response are not present. Therefore, the operator specifying unit 8 determines whether the response is to be registered into the response-information holding unit 9 as new response information (Step 534). When the response is not to be registered (NO at Step S34), the operation of the characteristic-change-time register process is returned. When the response is to be registered (YES at Step S34), the operator specifying unit 8 registers the response into the response-information holding unit 9 in the state that whether the operation is input at the seat 1a or at the seat 1b is not determined (Step S35). The operation of the characteristic-change-time register process is returned.

When the operation of the characteristic-change-time register process is returned, the operation returns to the flow in FIG. 6. The operator specifying unit 8 performs a comprehensive determination based on a result of the determination of the response corresponding to the electric signals of all patterns stored in the internal memory of the control unit 7, and establishes the determination whether the operation is input at the seat 1a or at the seat 1b (Step S21). When there is response information registered in the response-information holding unit 9 in the state that whether the operation is input at the seat 1a or at the seat 1b is not determined, the response information provides information about whether the operation is input at the seat 1a or at the seat 1b, based on a result of the final determination.

As described above, according to the second embodiment, the in-vehicle system further holds the change information which relates the response information for each seating region in which the operator is seated to the response obtained when the operator seated in the individual seating region is touching an item other than the seating region and the input unit. When the in-vehicle system detects the response when the operator operates the input unit, the in-vehicle system specifies the seating region in which the operator operates the input unit, from the detected response based on the response information and the change information. Therefore, even when the operator operates the input unit while touching an item other than the seating region and the input unit, the in-vehicle system can specify the seating region in which the operator is seated.

In the above embodiments, examples are explained where the in-vehicle system determines whether the operator operating the touch panel in the dual-view liquid-crystal display is a driver in the driver seat or a passenger in the passenger seat. However, an object to which the input system (the input device or the input method) disclosed in the present invention is applied is not limited to the dual-view liquid-crystal display. For example, the input system disclosed in the present invention can be also applied to an in-vehicle device using various liquid crystal displays such as a normal display instead of a dual-view liquid-crystal display or of a touch panel, and a display as a touch panel instead of a dual-view liquid-crystal display. Further, the input system disclosed in the present invention can be also applied to a display used in a state that the display needs to be shared by multiple persons in a university lecture or at a video conference, and the use is not limited to the in-vehicle device.

As described above, an electric signal is supplied between the input unit having a touch panel and an electric base, and a response is detected which passes between the input unit and the electric base via the operator and the seating region having an individual electric characteristic. The seating region in which the operator is seated is specified from the detected response, based on response information having the response related to each seating region. Therefore, the seating region of the operator can be specified without providing an electrode in the seating region.

Further, a seating region in which the operator is seated can be specified regardless of whether the operator seated in the seating region is wearing a securing device.

Further, the in-vehicle system further holds the change information which relates the response information for each seating region in which the operator is seated to the response obtained when the operator seated in the individual seating region is touching an item other than the seating region and the input unit. When the in-vehicle system detects the response when the operator operates the input unit, the in-vehicle system specifies the seating region in which the operator operates the input unit, from the detected response based on the response information and the change information. Therefore, even when the operator operates the input unit while touching an item other than the seating region and the input unit, the in-vehicle system can specify the seating region in which the operator is seated.

As described above, the input system, the input device, and the input method according to the present invention are useful to specify a seat in which an operator operating an input unit is seated, and particularly suitable to specify a seat without embedding an electrode into the seat.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An input system comprising:
an input unit having a touch panel;
a plurality of seating regions in which an operator can be seated, each of the seating region having an individual electric characteristic and connected to an electric base;
an electric-signal supply unit that supplies an electric signal to the input unit with respect to the electric base; and
a seating-region specifying unit that detects a response passing between the input unit and the electric base via the operator and the seating region in which the operator is seated, corresponding to the electric signal, when the operator operates the input unit, and that specifies the seating region in which the operator operating the input unit is seated from the detected response, based on response information having each seating region in which the operator is seated related to the response.

2. The input system according to claim 1, wherein each of the seating region has a securing device that secures the seated operator, and
the response information relates each of the seating region in which the operator is seated to the response, for each case that the operator is wearing the securing device and a case that the operator is not wearing the securing device.

3. The input system according to claim 1, wherein the seating-region specifying unit further includes change information that relates the response information for each of the seating region in which the operator is seated to the response obtained when the operator seated in the individual seating region is touching an item other than the individual seating region and the input unit, and when the seating-region specifying unit detects the response when the operator operates the input unit, the seating-region specifying unit specifies the seating region in which the operator operates the input unit, from the detected response based on the response information and the change information.

4. An input device comprising:
an input unit having a touch panel;
an electric-signal supply unit that supplies an electric signal to the input unit with respect to an electric base; and
a seating-region specifying unit that detects, when an operator seated in one of a plurality of seating regions in which the operator can be seated, each having an individual electric characteristic and connected to the electric base, operates the input unit, a response passing between the input unit and the electric base via the operator and the seating region in which the operator is seated, corresponding to the electric signal, and that specifies the seating region in which the operator operating the input unit is seated from the detected response, based on response information having each seating region in which the operator is seated related to the response.

5. An input method for specifying one of a plurality of seating regions in which an operator can be seated, each having an individual electric characteristic and connected to an electric base when the operator operates an input unit having a touch panel, the input method comprising:
supplying an electric signal to the input unit with respect to the electric base;
detecting a response passing between the input unit and the electric base via the operator and the seating region in which the operator is seated, corresponding to the electric signal, when the operator operates the input unit; and
specifying the seating region in which the operator operating the input unit is seated from the detected response, based on response information having each seating region in which the operator is seated related to the response.
